(19) United States
(12) Patent Application Publication
(10) Pub. No.: US 2006/0165042 A1
(43) Pub. Date: Jul. 27, 2006

(54) System for immediate retransmission over WLAN and method therefor

(75) Inventor: Hao-Li Wang, Taipei City (TW)

Correspondence Address: BACON & THOMAS, PLLC, 625 SLATERS LANE, FOURTH FLOOR, ALEXANDRIA, VA, 22314, US

(73) Assignee: Institute For Information Industry, Taipei City (TW)

(21) Appl. No.: 11/038,109

(22) Filed: Jan. 21, 2005

(51) Int. Cl. H04B 7/212

(52) U.S. Cl. 370/338

(57) ABSTRACT

Provided is a system for immediate retransmission over WLAN and a method therefor. The system includes a first mobile station, a second mobile station, and an AP or LN. The first mobile station intends to transmit data to the second mobile station. The method comprises in a data transmission stage causing the first mobile station to transmit a data frame to the second mobile station; in a retransmission request stage causing the AP or the LN to broadcast a retransmission.request in response to detecting that the second mobile station fails to receive the data frame; and in an immediate retransmission stage causing the first mobile station to immediately retransmit the data frame in response to receiving the retransmission.request.

### BACKGROUND OF THE INVENTION

1. Field of the Invention

The present invention relates to a wireless local area network (WLAN) and, more particularly, to a system for performing an immediate retransmission over a WLAN and a method therefor.

2. Description of Related Art

The existing IEEE 802.11 standard for WLAN was published in 1997. In the IEEE 802.11 standard, physical layer (PHY) and medium access control (MAC) operations are defined. Also, rules of wireless medium access are defined in the IEEE 802.11 distributed coordination function (DCF). Wireless networks have now become a particularly common network. DCF is a contention based function and it takes advantages of the carrier sense multiple access/collision avoidance (CSMA/CA) technique for controlling access. DCF takes a positive acknowledgement (ACK) as means for determining whether receiving is correct or not since WLAN is not a reliable transmission medium. As shown in FIG. 1(a), a positive ACK means an ACK is replied when a receiving terminal successfully receives a data frame in the process of a transmitting terminal is transmitting the data frame to the receiving terminal. The transmitting terminal will transmit a next data frame only after it has confirmed that the previous data frame has been received successfully. To the contrary, the transmitting terminal confirms that the previous data frame is lost (i.e., transmission failure) if no ACK is received after a retransmission timeout has expired. Next, a retransmission of the same data frame is performed as shown in FIG. 1(b).

With reference to FIG. 2, it is shown that a transmitting terminal has waited a long period of time (e.g., retransmission timeout) before retransmitting the lost data frame. All other mobile stations connected to the wireless network are idle during the retransmission timeout. This inevitably wastes the precious network resource and lowers network system performance. Hence, a need for decreasing the times of timeout occurrence and thus increasing channel reuse ratio exists.

### SUMMARY OF THE INVENTION

An object of the present invention is to provide a system for immediate retransmission over a WLAN and a method therefor so as to decrease the times of timeout occurrence, increase channel reuse ratio, and thus increase network system performance.

One aspect of the present invention is to provide in a WLAN system including a first mobile station, a second mobile station, and an AP or LN wherein the first mobile station intends to transmit data to the second mobile station, a method for an immediate retransmission comprising the steps of in a data transmission stage causing the first mobile station to transmit a data frame to the second mobile station; in a retransmission request stage causing the AP or the LN to broadcast a retransmission.request in response to detecting that the second mobile station fails to receive the data frame; and in an immediate retransmission stage causing the first mobile station to immediately retransmit the data frame in response to receiving the retransmission.request.

Another aspect of the present invention is to provide a system for an immediate retransmission over a WLAN, comprising a first mobile station for transmitting a data frame; a second mobile station for receiving the data frame; and an AP or LN adapted to broadcast a retransmission.request in response to detecting that the second mobile station fails to receive the data frame, wherein the first mobile station is adapted to immediately retransmit the data frame in response to receiving the retransmission.request.

Other objects, advantages, and novel features of the invention will become more apparent from the detailed description when taken in conjunction with the accompanying drawings.

### BRIEF DESCRIPTION OF THE DRAWINGS

FIGS. 1(a) and 1(b) show processes of a failed data transmission from the transmitting terminal to the receiving terminal and a retransmission thereof over WLAN respectively;

FIG. 2 presents a feasible signaling of a prior method in transmitting a data frame and a subsequent retransmission of the lost data frame;

FIG. 3 illustrates a WLAN system operating according to a first preferred embodiment of the invention for performing an immediate retransmission in response to data loss;

FIG. 4 presents a feasible signaling of a method according to the invention in transmitting a data frame and an immediate retransmission of the lost data frame; and

FIG. 5 illustrates a WLAN system operating according to a second preferred embodiment of the invention for performing an immediate retransmission in response to data loss.

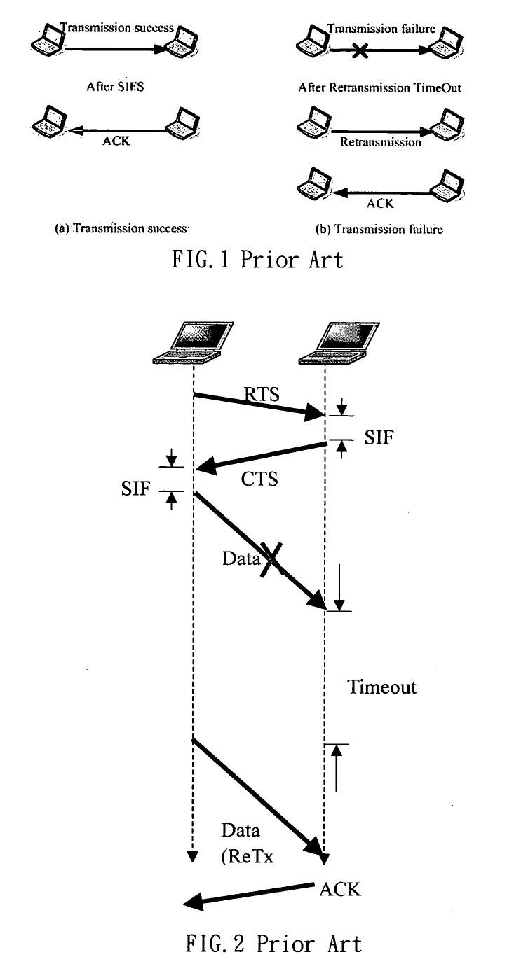

### DETAILED DESCRIPTION OF THE PREFERRED EMBODIMENT

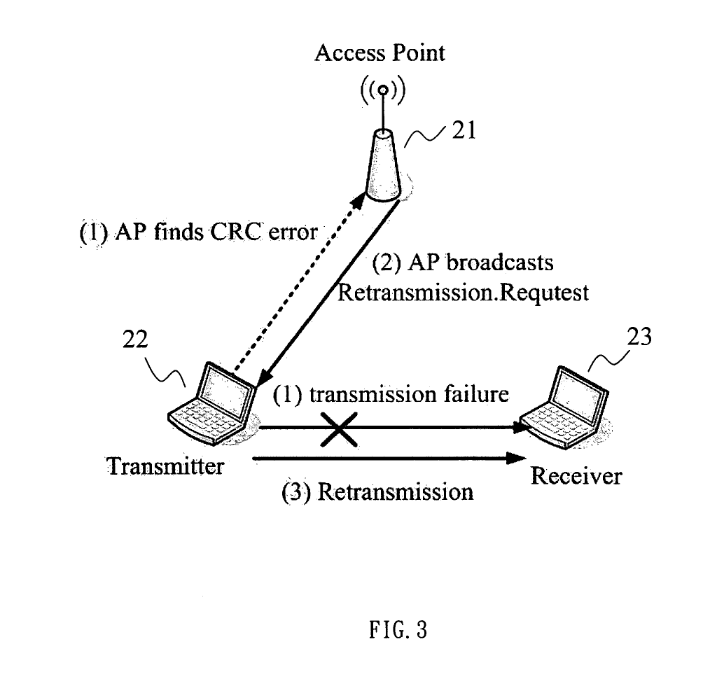

With reference to FIG. 3, there is shown a WLAN system operating according to a first preferred embodiment of the invention for performing an immediate retransmission in response to data loss. The WLAN is an infrastructure WLAN having an access point (AP). As shown, two mobile stations 22 and 23 are in a service area of an AP 21. That is, the mobile station 22 is able to transmit a data frame to the mobile station 23 directly.

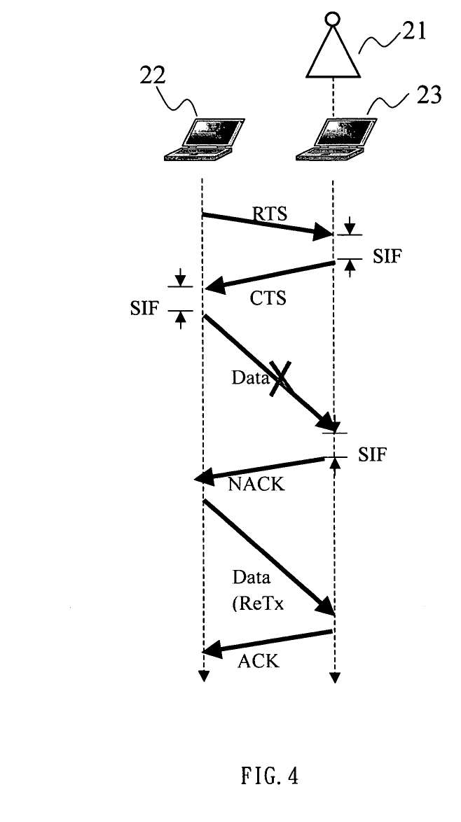

With reference to FIG. 4 in conjunction with FIG. 3, it presents a feasible signaling of a method according to the invention in transmitting a data frame and an immediate retransmission of the lost data frame. In detail, mobile station 22 (i.e., transmitting terminal) is transmitting a request to send (RTS) to a mobile station 23 (i.e., receiving terminal) prior to data transmission. After receiving the data frame, the mobile station 23 will wait a SIFT (short inter frame space) of time prior to transmitting a clear to send (CTS) in response. After receiving the CTS, the mobile station 22 will transmit a data frame to the mobile station 23 after the SIFS of time has expired.

At this time, AP 21 monitors all transmitted data frames. If AP 21 detects that mobile station 23 successfully receives the data frame and AP 21 also successfully receives the data frame, mobile station 23 will wait a SIFS of time prior to replying with an ACK. To the contrary, if AP 21 detects that there is a frame loss (i.e., a (cyclical redundancy check) CRC error is found by AP 21 after receiving the data frame) and mobile station 23 is unable to successfully receive the data frame, AP 21 broadcasts a retransmission.request to all transmitters (i.e., mobile station 22) since data has been lost and also AP 21 is not aware which mobile station previously transmitted the data frame. Mobile station 22 is informed of the retransmission.request and is thus able to immediately retransmit the lost data frame without contention.

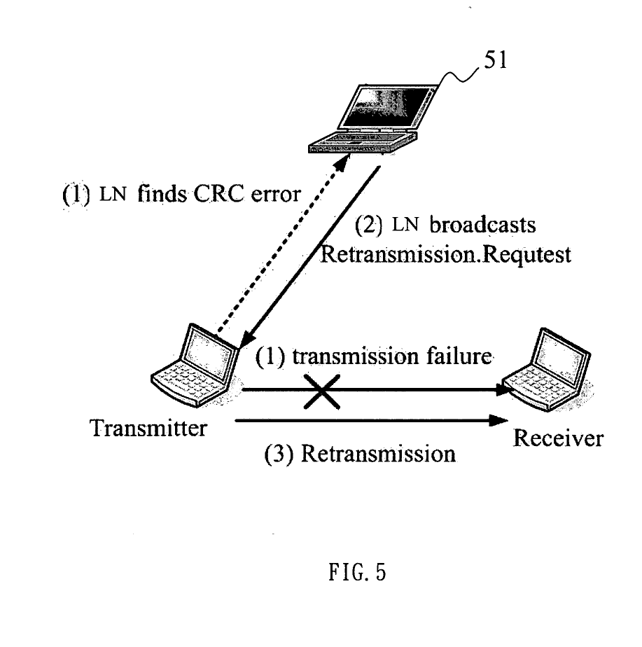

With reference to FIG. 5, there is illustrated a WLAN system operating according to a second preferred embodiment of the invention for performing an immediate retransmission in response to data loss. This WLAN system is an ad hoc network system having a leader node (LN) (i.e., a node of the network system transmitting a first synchronous signal) 51 as a replacement of the above AP 21. Likewise, LN 51 monitors all transmitted data frames. If LN 51 detects that there is a frame loss, LN 51 broadcasts a retransmission.request to all transmitters. The informed transmitter is thus able to immediately retransmit the lost data frame without contention.

In view of the above, the invention is able to detect all data frames transmitted from one mobile station to the other mobile station by means of AP or LN by broadcasting. In case of frame loss due to signal interference or collision, AP or LN can detect such loss by finding a CRC error. AP or LN will immediately broadcast a retransmission.request to the transmitter about the frame loss within a SIFS of time. The informed transmitter is thus able to immediately retransmit the lost data frame without waiting a period of time. As such, the invention can eliminate both unnecessary timeout and bandwidth waste. Further, the invention can increase the network system performance by taking advantage of the precious network resource. Furthermore, the invention can increase retransmission speed. In addition, the invention can operate normally even in an environment having high frame loss ratio. Moreover, the invention is fully compatible with the existing IEEE 802.11 standard.

While the invention herein disclosed has been described by means of specific embodiments, numerous modifications and variations could be made thereto by those skilled in the art without departing from the scope and spirit of the invention set forth in the claims.

What is claimed is:

1. In a WLAN system including a first mobile station, a second mobile station, and an AP wherein the first mobile station intends to transmit data to the second mobile station, a method for an immediate retransmission comprising the steps of:
in a data transmission stage causing the first mobile station to transmit a data frame to the second mobile station;
in a retransmission request stage causing the AP to broadcast a retransmission.request in response to detecting that the second mobile station fails to receive the data frame; and
in an immediate retransmission stage causing the first mobile station to immediately retransmit the data frame in response to receiving the retransmission.request.

2. The method of claim 1, further comprising the step of:
in an ACK replying stage in response to successfully receiving the data frame causing the second mobile station to wait a SIFS of time prior to replying to the first mobile station with an ACK.

3. The method of claim 1, wherein before the data transmission stage further comprises the steps of:
in a RTS transmission stage causing the first mobile station to transmit an RTS to the second mobile station; and
in a CTS response stage in response to successfully receiving the RTS causing the second mobile station to wait a SIFS of time prior to replying to the first mobile station with a CTS.

4. The method of claim 3, wherein in the data transmission stage in response to successfully receiving the CTS the first mobile station waits a SIFS of time prior to transmitting the data frame to the second mobile station.

5. In a WLAN system including a first mobile station, a second mobile station, and an LN wherein the first mobile station intends to transmit data to the second mobile station, a method for an immediate retransmission comprising the steps of:
in a data transmission stage causing the first mobile station to transmit a data frame to the second mobile station;
in a retransmission request stage causing the LN to broadcast a retransmission.request in response to detecting that the second mobile station fails to receive the data frame; and
in an immediate retransmission stage causing the first mobile station to immediately retransmit the data frame in response to receiving the retransmission.request.

6. The method of claim 5, further comprising the step of:
in an ACK replying stage in response to successfully receiving the data frame causing the second mobile station to wait a SIFS of time prior to replying to the first mobile station with an ACK.

7. The method of claim 5, wherein before the data transmission stage further comprises the steps of:
in an RTS transmission stage causing the first mobile station to transmit an RTS to the second mobile station; and
in a CTS response stage in response to successfully receiving the RTS causing the second mobile station to wait a SIFS of time prior to replying to the first mobile station with a CTS.

8. The method of claim 7, wherein in the data transmission stage in response to successfully receiving the CTS the first mobile station waits a SIFS of time prior to transmitting the data frame to the second mobile station.

9. A system for an immediate retransmission over a WLAN, comprising:
a first mobile station for transmitting a data frame;
a second mobile station for receiving the data frame; and
an AP adapted to broadcast a retransmission.request in response to detecting that the second mobile station fails to receive the data frame,
wherein the first mobile station is adapted to immediately retransmit the data frame in response to receiving the retransmission.request.

10. A system for an immediate retransmission over a WLAN, comprising:
a first mobile station for transmitting a data frame;
a second mobile station for receiving the data frame; and
an LN adapted to broadcast a retransmission.request in response to detecting that the second mobile station fails to receive the data frame,
wherein the first mobile station is adapted to immediately retransmit the data frame in response to receiving the retransmission.request.
